(19) United States
(12) Patent Application Publication
(10) Pub. No.: US 2014/0330543 A1
(43) Pub. Date: Nov. 6, 2014

(54) METHOD FOR DESIGNING LENS

(71) Applicant: HON HAI PRECISION INDUSTRY CO., LTD., New Taipei (TW)

(72) Inventor: LI-YING WANG HE, Tu-Cheng (TW)

(73) Assignee: HON HAI PRECISION INDUSTRY CO., LTD., New Taipei (TW)

(21) Appl. No.: 13/961,700

(22) Filed: Aug. 7, 2013

(30) Foreign Application Priority Data
May 2, 2013 (TW) 102115678

(51) Int. Cl. G06F 17/50

(52) U.S. Cl. CPC G06F 17/50
USPC 703/1

(57) ABSTRACT

A method for designing a lens is disclosed. Multiple coordinates of an optical face of the lens are set according to formulas of Xₙ=Xₙ₋₁+Dₙ₋₁; and Yₙ=Yₙ₋₁+Kₙ₋₁*Dₙ₋₁. The coordinates are then connected by lines to form a primary curve of the optical face. A test is made to the primary curve to find unsatisfied coordinates. The unsatisfied coordinates are updated by amending the slopes thereof. The updated coordinates are then connected with the unchanged coordinates by lines to obtain an update curve. The update curve is further tested and amended until a satisfied curve is obtained.

### BACKGROUND

1. Technical Field

The disclosure generally relates to a method, and more particularly, to a method for designing a lens.

2. Description of Related Art

Lens is an important optical element for adjusting light. A lens generally has a complicated optical face to achieve a desired light distribution. However, the complicated optical face of the lens is difficult to design, thereby resulting in high cost of the lens.

What is needed, therefore, is a method for designing a lens which can address the limitations described.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the various views.

FIG. 1 shows a lens designed by a method in accordance with an embodiment of the present disclosure.

FIG. 2 shows a primary curve and an update curve of an optical face of the lens of FIG. 1.

### DETAILED DESCRIPTION

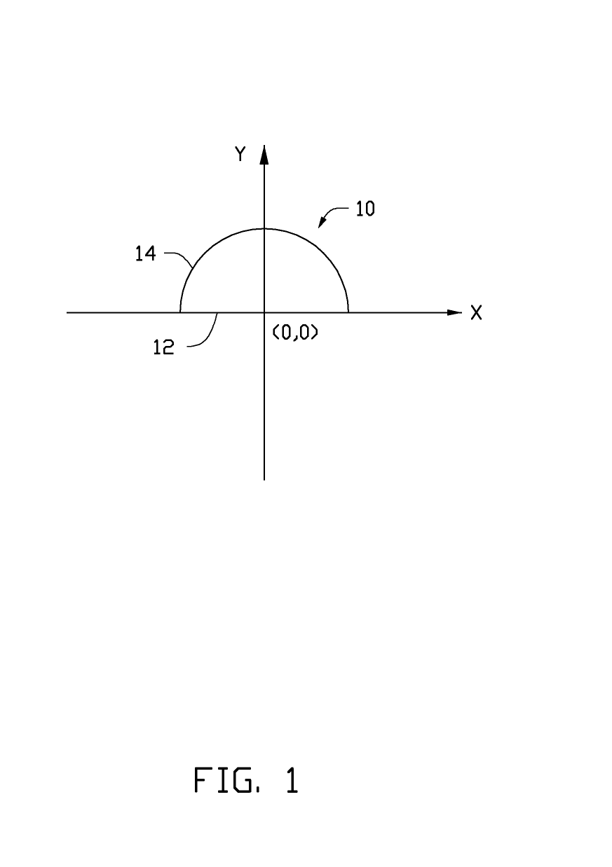

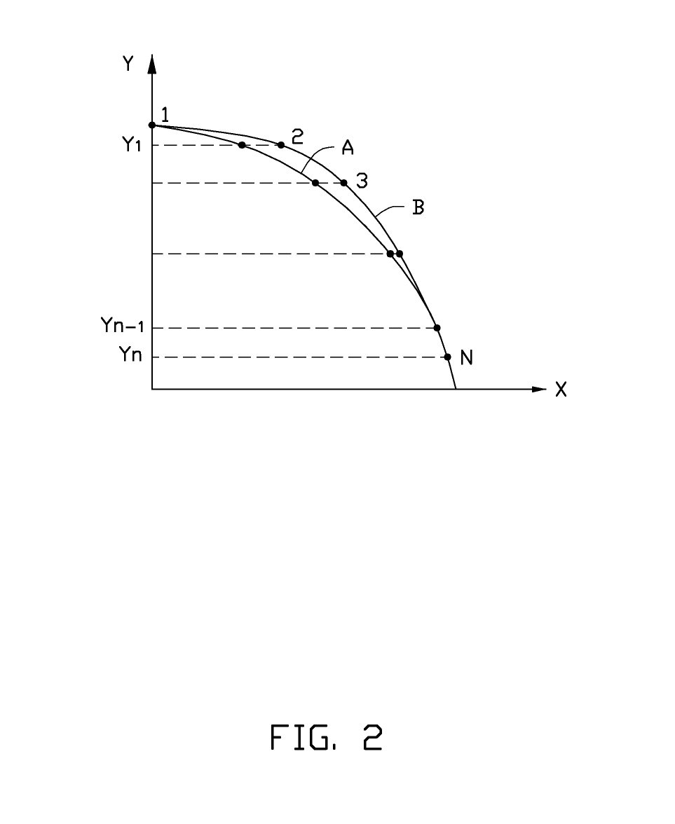

Referring to FIGS. 1-2, a method for designing a lens 10 in accordance with an embodiment of the present disclosure is shown. The method mainly includes following steps:

Firstly, a coordinate system is set for the lens. The coordinate system includes an X axis and a Y axis perpendicular to the X axis. The X axis intersects with the Y axis at a coordinate (0, 0). A center of a bottom face 12 of the lens 10 is located on the coordinate (0, 0). A center of an optical face 14 of the lens 10 is located on a coordinate (X₁, Y₁). The coordinate (X₁, Y₁) is a start coordinate of the optical face 14 of the lens 10. Since the center of the optical face 14 is located on the Y axis, the start coordinate can also be represented as (0, Y₁). Left and right curves of the optical face 14 are symmetrical with the Y axis. Only the right curve of the optical face 14 is discussed below for brevity.

A first reference value is set for the optical face 14 of the lens 10 in order to calculate a second coordinate (X₂, Y₂) of the optical face 14 of the lens 10. The first reference value includes a first reference slope K₁ and a first reference distance D₁. K₁ is a slope of the second coordinate relative to the first coordinate, and D₁ is a difference between the second coordinate and the first coordinate in the X axis. The second coordinate of the optical face 14 of the lens 10 is obtained by substituting the primary coordinate (0, Y₁) into a formula Xₙ=Xₙ₋₁+Dₙ₋₁; and Yₙ=Yₙ₋₁Kₙ₋₁*Dₙ₋. Thus, the second coordinate is calculated as (D₁, Y₁+K₁*D₁). In this embodiment, the value of K₁ is a negative number so that Y₂ is smaller than Y₁.

A second reference value is further set for the optical face 14 of the lens 10 in order to calculate a third coordinate (X₃, Y₃) of the optical face 14 of the lens 10. The second reference value includes a second reference slope K₂ and a second reference distance D₂. K₂ is a slope of the third coordinate relative to the second coordinate, and D₂ is a difference between the third coordinate and the second coordinate in the X axis. The third coordinate (X₃, Y₃) of the optical face 14 of the lens 10 is obtained by substituting the second coordinate (X₂, Y₂) into the formula Xₙ=Xₙ₋₁+Dₙ₋₁; and Yₙ=Yₙ₋₁+Kₙ₋₁*Dₙ₋₁. Thus, the third coordinate is calculated as (D₁+D₂, Y₁+K₁*D₁+K₂*D₂). In this embodiment, the value of K₂ is a negative number so that Y₃ is smaller than Y₂.

Next coordinates of the optical face 14 of the lens 10 are further calculated by repeating the above steps. An arbitrary coordinate (Xₙ, Yₙ) is presented as (D₁+D₂+D₃+D₄+ . . . Dₙ₋₁, Y₁+K₂*D₁+K₂*D₂+K₃*D₄+ . . . Kₙ₋₁*Dₙ₋₁). Every two adjacent coordinates of the optical face 14 of the lens 10 is then connected by a line. All the lines cooperatively construct a primary curve A of the optical face 14 of the lens 10. In order to simplify calculation of the optical face 14 of the lens 10, each reference distance can be equal to each other, i.e., D₁=D₂=D₃=D₄= . . . Dₙ. Thus, the arbitrary coordinate (Xₙ, Yₙ) can also be presented as ((n−1)*D₁, Y₁+(K₁+K₂+K₃+ . . . Kₙ)*(n−1)*D₁).

Finally, the primary curve A of the optical face 14 of the lens 10 is tested to determine whether the primary curve A meets light distribution requirement of the optical face 14 of the lens 10. If a section of the primary curve A does not meet the light distribution requirement, the coordinates within the section should be amended. Assuming that the coordinates within the section range between (Xₘ₋₁, Yₘ₋₁) and (Xₘ, Yₘ), the slope of each coordinate within the section is amended to another value according to the required light distribution, and then new coordinates within the section are recalculated according to the amended slopes. The new coordinates are presented as (D₁+D₂+D₃+D₄+ . . . Dₘ₋₂, Y₁+K₁*D₁+K₂*D₂+K₃*D₄+ . . . Kₘ₋₂′*Dₘ₋₂) and (D₁+D₂+D₃+D₄+ . . . Dₘ₋₂+Dₘ₋₁, Y₁+K₁*D₁+K₂*D₂+K₃*D₄+ . . . Kₘ₋₂′*Dₘ₋₂+Kₘ₋₁′*Dₘ₋₁), wherein Kₘ₋₂′ and Kₘ₋₁′ are the amended slopes of the new coordinates. The new coordinates are then connected to unchanged coordinates (i.e., the coordinates outside the range of the section) by lines to obtain an updated curve B of the optical face 14 of the lens 10. The updated curve B is further tested to determine whether required light distribution is achieved. If not, corresponding coordinates are amended again to correct the updated curve B as the above steps, until a satisfied curve of the optical face 14 of the lens 10 is obtained.

The lens 10 can be easily and conveniently designed according to the method as disclosed above. Thus, cost of the lens 10 is reduced accordingly.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for designing a lens, comprising:
setting a first coordinate (X₁, Y₁) as a start of an optical face of the lens;
giving a first reference slope K₁ and a first reference distance D₁, calculating a second coordinate (X₂, Y₂) by substituting the first coordinate (X₁, Y₁), the first reference slope K₁ and the first reference distance D₁ into formulas of Xₙ=Xₙ₋₁+Dₙ₋₁; and Yₙ=Yₙ₋₁+Kₙ₋₁*Dₙ₋₁, thereby obtaining the second coordinate (X₂, Y₂) as (X₁+D₁, Y₁+K₁*D₁);
repeating the above steps and obtaining next coordinates by using the formulas of Xₙ=Xₙ₋₁+Dₙ₋₁; and Yₙ=Yₙ₋₁+Kₙ₋₁*Dₙ₋₁, an nth coordinate (Xₙ, Yₙ) being represented as (X₁+D₁+D₂+D₃+D₄+ . . . Dₙ₋₁, Y₁+K₁*D₁+K₂*D₂+K₃*D₄+ . . . Kₙ₋₁*Dₙ₋₁);
sequentially connecting the coordinates by lines, thereby obtaining a primary curve of the optical face of the lens;
testing the primary curve of the optical face of the lens and finding an unsatisfied coordinate (Xₘ, Yₘ);
amending the primary curve of the optical face of the lens by steps:
giving a new reference slope Kₘ₋₁′ to replace a original slope Kₘ₋₁ of the unsatisfied coordinate (Xₘ, Yₘ);
obtaining a new coordinate (Xₘ′, Yₘ′) according to the new reference slope Kₘ₋₁′; and
connecting the new coordinate (Xₘ′, Yₘ′) with unchanged coordinates to obtain an update curve of the optical face of the lens.

2. The method of claim 1 further comprising testing the updated curve of the optical face of the lens, and repeating the amending steps if the updated curve of the optical face of the lens is still unsatisfied.

3. The method of claim 1, wherein D₁=D₂=D₃=D₄= . . . Dₙ.

4. The method of claim 3, wherein the nth coordinate (Xₙ, Yₙ) is represented as (X₁+(n'11)*D₁, Y₁+(K₁+K₂−K₃+ . . . Kₙ₋₁)*(n−1)*D₁).

5. The method of claim 1, wherein Xₘ=Xₘ′.

6. The method of claim 5, wherein the unsatisfied coordinate (Xₘ, Yₘ) is presented as (X₁+D₁+D₂+D₃+D₄+ . . . Dₘ₋₁, Y₁+K₁*D₁+K₂*D₂+K₃*D₄+ . . . Kₘ₋₁*Dₘ₋₁), and the new coordinate (Xₘ′, Yₘ′) is presented as (X₁+D₁+D₂+D₃+D₄+ . . . Dₘ₋₁, Y₁+K₁*D₁+K₂*D₂+K₃*D₄+ . . . Kₘ₋₁′*Dₘ₋₁).

7. The method of claim 1, wherein X₁=0.

8. The method of claim 7, wherein the lens further comprises a bottom face, a center of the bottom face of the lens being located at a coordinate (0, 0).
